(19) United States
(12) Patent Application Publication
(10) Pub. No.: US 2025/0293556 A1
(43) Pub. Date: Sep. 18, 2025

(54) STATOR TO ROTOR RETENTION CLIP

(71) Applicant: Black & Decker Inc., New Britain, CT (US)

(72) Inventors: DAVID J. SMITH, Columbia, MD (US); AUSTIN L. GANZERMILLER, Reisterstown, MD (US)

(73) Assignee: Black & Decker Inc., New Britain, CT (US)

(21) Appl. No.: 18/607,973

(22) Filed: Mar. 18, 2024

(51) Int. Cl. H02K 1/18; B25B 21/02; B25F 5/02; H02K 5/15; H02K 7/14; H02K 21/16

(52) U.S. Cl. CPC H02K 1/185; B25F 5/02; H02K 5/15; H02K 7/145; H02K 21/16; B25B 21/02

(57) ABSTRACT

A power tool is provided including a housing including a first housing half and a second housing half mating together along a mating plane, and an electric motor disposed within the housing. The electric motor includes a stator having a plurality of stator windings, a rotor shaft extending within the stator along a longitudinal axis, a rotor having a plurality of magnets and mounted on the rotor shaft within the stator, and a bearing support structure located adjacent the stator to support a bearing mounted on the rotor shaft. At least one retention clip is radially mounted on the electric motor to retain the stator relative to the bearing support structure.

### FIELD

This disclosure relates to an electric motor, and particularly to a retention clip for coupling a stator and a rotor of an electric motor.

### BACKGROUND

Power tools such as impact drivers and impact wrenches may be used for driving threaded fasteners into workpieces. Electric motors such as brushless direct-current (BLDC) motors may be utilized within such power tools. A BLDC motor includes a stator including a set of coils that are energized in a controlled sequence, and a rotor including permanent magnets that magnetically interact with the stator coils to cause a rotation of the rotor relative to the stator. Typically, the electric motor is provided as a unitary modular unit, with two end caps (i.e., bearing support structures) provided to pilot and support two rotor bearings relative to the stator, thus fixing the rotor axially and radially while allowing it to freely rotate relative to the stator. An example of this arrangement may be found in US Patent Publication No. 2022/0320960 filed Jun. 22, 2022, which is incorporated herein by reference in its entirety. In another configuration, a dedicated motor housing that pilots and supports the rotor relative to the stator. Specifically, the motor housing integrally includes support features that secure two rotor bearings relative to the stator, thus fixing the rotor axially and radially while allowing it to freely rotate relative to the stator. Examples of this arrangement may be found in US Patent Publication No. 2016/0149463 filed Nov. 25, 2015, and US Patent Publication No. 2017/0110945 filed Oct. 13, 2016, both of which are incorporated herein by reference in their entireties.

In yet another configuration, a tool housing (e.g., a plastic clamshell that forms the body of the power tool) is utilized for providing the needed support and retention features to properly support and pilot the rotor and the stator components. In some examples, the tool housing is provided with a series of retaining ribs that engage the stator and a support structure of the rotor. This type of motor is commonly referred to as a frameless motor, as it does not independently include a frame for keeping the motor components together. An example of such an arrangement may be found in US Patent Publication No. 2020/0169142 filed Jan. 29, 2020, which is incorporated herein by reference in its entirety. Here, the motor is provided with two end cap that provide support structures for two rotor bearings and are piloted via a series of posts to the inner surface of the stator. The two end caps and the stator are not fastened together. Rather, the power tool housing includes retention features that rotationally and axially constrains and supports these components relative to one another. The power tool housing includes a clamshell construction, which each housing half including the required retention features. When the housing halves mate together around the motor, the retention features engage the stator and the two end caps to provide rotational and axial structural support for the motor.

Frameless motors as described above are not suitable for use in power tools where the tool housing does not have the appropriate support and retention features. In particular, where the housing halves are not designed to mate around the motor as described above, the housing cannot be provided with features to support the motor components. The present disclosure seeks to address this problem.

### SUMMARY

A power tool is provided comprising a housing including a first housing half and a second housing half mating together along a mating plane; and an electric motor disposed within the housing. The electric motor includes a stator having a plurality of stator windings, a rotor shaft extending within the stator along a longitudinal axis, a rotor having a plurality of magnets and mounted on the rotor shaft within the stator, and a bearing support structure located adjacent the stator to support a bearing mounted on the rotor shaft. At least one retention clip is radially mounted on the electric motor to retain the stator relative to the bearing support structure.

In an embodiment, the stator includes a stator core and an end insulator mounted on an axial end of the stator core to electrically insulate the plurality of stator windings from the stator core, wherein the at least one retention clip engages the end insulator.

In an embodiment, the bearing support structure is in contact with the end insulator and the at least one retention clip engages opposite surfaces of the end insulator and the bearing support structure to radially and axially pilot and support the rotor relative to the stator.

In an embodiment, the end insulator includes circumferential pockets formed in its outer surface, and the at least one retention clip is configured to engage at least one of the plurality of circumferential pockets.

In an embodiment, the longitudinal axis is substantially perpendicular to the mating plane.

In an embodiment, the first housing half includes a motor housing portion that substantially surrounds the electric motor.

In an embodiment, the second housing half includes a motor plate that mates with the motor housing portion to house the electric motor. The motor plate includes a front bearing support structure that supports a front bearing mounted on the rotor shaft to provide structural support for the rotor. At least one retaining feature coupled to the stator to provide structural support for the stator.

In an embodiment, the motor housing portion includes at least one interior wall that holds the at least one retention clip in engagement with the stator and the bearing support structure.

In an embodiment, the at least one retention clip comprises two retention clips positioned on opposite circumferential sides of the electric motor.

In an embodiment, each retention clip includes a main body having curvature and extends laterally around an angular width of approximately 60 degrees to 120 degrees of the circumference of the electric motor, a front tab extending radially inwardly from the main body that engage the stator, and a rear tab extending radially inwardly from the main body that engages the bearing support structure.

In an embodiment, an axial distance between the front tab and the rear tab is configured to ensure that the front and rear tabs fully engage the stator and the bearing support structure only when the bearing support structure is fully mounted relative to the stator.

In an embodiment, each retention clip is a metal clip comprising stamped metal shaped to include a plurality of legs that engage the stator and the bearing support structure.

In an embodiment, the electric motor includes a frameless structure with no fasteners that fasten the stator to the bearing support structure.

In an embodiment, an electric motor is provided including: a stator having a plurality of stator windings; a rotor shaft extending within the stator along a longitudinal axis; a rotor having a plurality of magnets and mounted on the rotor shaft within the stator; a bearing support structure located adjacent the stator to support a bearing mounted on the rotor shaft; and at least one retention clip radially mounted on the electric motor to retain the stator relative to the bearing support structure.

### BRIEF DESCRIPTION OF THE DRAWINGS

The drawings described herein are for illustrative purposes only of selected embodiments and not all possible implementations and are not intended to limit the scope of the present disclosure.

FIG. 1 depicts an exploded perspective view of a first power tool including support and retention features for an electric motor, according to an embodiment.

FIG. 2 depicts a top cross-sectioned view of the first power tool, according to an embodiment.

FIG. 3 depicts an exploded perspective view of a second power tool provided with a retention clip member to support the motor components, according to an embodiment.

FIG. 4 depicts an exploded side view of the second power tool, according to an embodiment.

FIGS. 5A and 5B depict exploded view of the electric motor and the retention clip, according to an embodiment.

FIG. 6 depicts a perspective view of the electric motor provided with a metal clip, according to an alternative embodiment.

FIG. 7 depict a partial perspective view of the electric motor with the metal clip mounted, according to an embodiment.

FIG. 8 depicts a side cross-sectional view of the second power tool including the electric motor, with the retention clip and the metal clip mounted on two sides of the electric motor, according to an embodiment.

Corresponding reference numerals indicate corresponding parts throughout the several views of the drawings.

### DETAILED DESCRIPTION

Example embodiments will now be described more fully with reference to the accompanying drawings. It is to be understood that both the foregoing general description and the following detailed description are exemplary and explanatory only and are intended to provide an explanation of various embodiments of the present teachings.

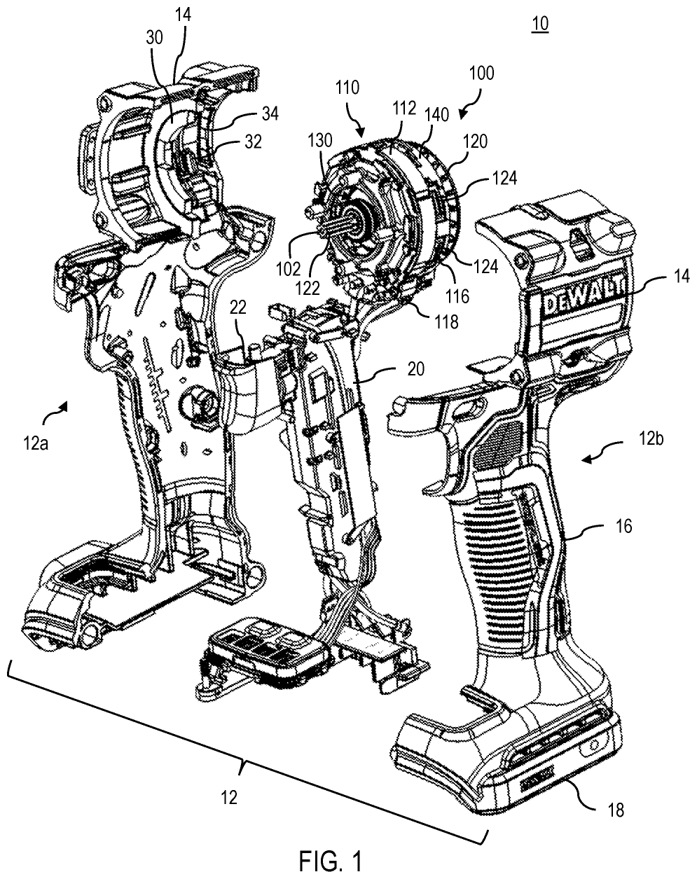

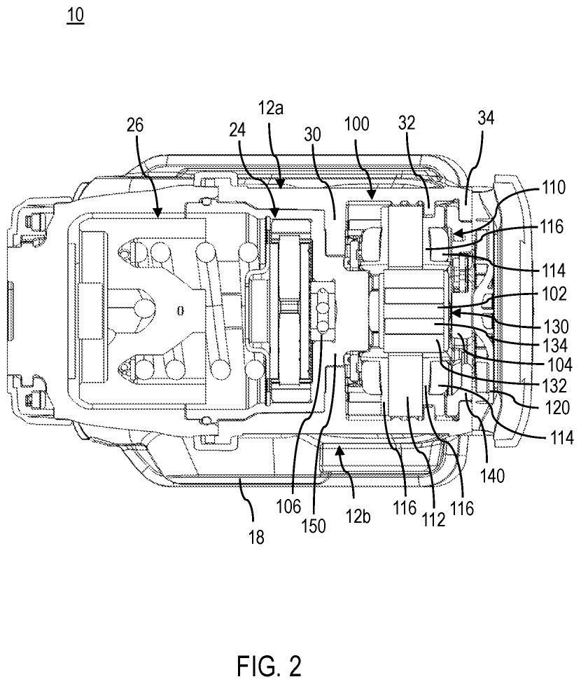

FIG. 1 depicts an exploded perspective view of a first power tool 10 including support and retention features for an electric motor 100, according to an embodiment. FIG. 2 depicts a top cross-sectioned view of the first power tool 10, according to an embodiment.

Power tool 10 in the particular example provided may be an impact wrench, but it will be appreciated that the teachings of this disclosure is merely exemplary, and the power tools described in this disclosure may be any type of electric power tool including a drill, impact driver, hammer, grinder, circular saw, reciprocating saw, or any similar portable power tool constructed in accordance with the teachings of this disclosure.

In an embodiment, the first power tool 10 may include a tool housing 12 formed by two housing halves 12a and 12b in a clamshell arrangement. The tool housing 12 forms a motor housing portion 14 that houses the electric motor 100 and a handle portion 16 extending from the motor housing portion 14 and forms a battery receptacle 18 for receiving a removeable power tool battery pack (not shown). The handle portion 16 in this example houses a control module 20 that integrally includes an input unit (e.g., a variable speed trigger assembly) 22 and controls a flow of electric current from the battery pack to the electric motor. The motor is drivably coupled to a transmission assembly 24 and an impact mechanism 26 (see FIG. 2), which include gear and impact components for imparting rotary and/or hammering impact on an output spindle.

In an embodiment, electric motor 100 is a brushless direct-current (BLDC) motor including an outer stator 110 and an inner rotor 130. The rotor 130 is mounted on a rotor shaft 102 and causes rotation of the rotor shaft 102 as it rotates relative to the stator 110.

In an embodiment, the stator 110 includes a stator core 112 (i.e., a lamination stack) formed from a series of laminated sheets of metal, and a series of stator windings (or coils) 114 would around inwardly projecting teeth of the stator core 112. Two end insulators 116 are mounted on two axial ends of the stator core 112 prior to the stator windings 114 being wound. End insulators 116 provide electrical insulation between the stator windings 114 and the stator core 112, which prevents electrical shortage between the stator windings 114. The stator windings 114 are connected in a predetermined winding pattern such as, for example, a series-delta, a parallel-dela, a series-wye, or a parallel-wye configuration. A series of stator terminals 118 are coupled to the stator to supply electric current from the control module 20 to the stator windings 114.

In an embodiment, rotor 130 includes a rotor core 132 that supports a series of permanent magnets 134. The permanent magnets 134 form a plurality of magnetic poles (e.g., in a N—S—N—S orientation), which magnetically interact with the stator windings 114 as the windings are energizes and cause rotation of the rotor 130.

The rotor shaft 102, on which the rotor 130 is mounted, is supported relative to the stator 110 via rear and front bearings 104 and 106. The rear bearing 104 includes an inner race that is securely mounted on the shaft 102 and an outer race that is secured within a rear bearing support structure 140. The rear bearing support structure 140 includes a central pocket that axially and radially supports the rear bearing 104 in place. In this embodiment, the rear bearing support structure 140 includes a body with an outer diameter that approximately matches the outer diameter of the stator 110. Similarly, the front bearing 106 includes an inner race that is securely mounted on the shaft 102 and an outer race that is secured within a front bearing support structure 150. The front bearing support structure 150 includes a central pocket that axially and radially supports the rear bearing 104 in place. In this embodiment, the front bearing support structure 150 is provided with an integrated support structure for the transmission assembly 24 and is supported via an interior wall 30 of the housing 12. The rotor shaft 102 is drivably coupled to a cooling fan 120 for cooling the motor on one side and to a pinion 122 that drives the transmission assembly 24 on the other side.

In an embodiment, electric motor 100 is provided with a frameless structure. Thus, the rear bearing support structure 140, the stator 110, and the front bearing support structure 150 are not secured together (e.g., via screws or other means) independently of the tool housing 12. Rather, the tool housing 12 includes retaining features that hold these components together. These retaining features include a series of more retaining tabs 32 that penetrates corresponding pockets 124 of one or both of the end insulator 116 to axially, radially, and rotationally fix the stator 110 within the housing 12. The retaining features further include a retaining rear wall 34 that engages and axially constrains a rear surface of the rear bearing support structure 140, causing it to remain fixed to the stator 110. It is noted that the rear bearing support structure 140 includes piloting features that rotationally and radially fixes it to the stator 110 once it is axially constrained. The front bearing support structure 150 is secured (e.g., via press-fitting or other retaining mechanism) to the housing 12 and is thus axially, radially, and rotationally fixed relative to the stator 110.

Proper support and assembly of the above-described frameless structure of the motor 100 is made possible by the clamshell structure of the housing 12 around the periphery of the motor 100. Specifically, the mating plane of the housing halves 12a and 12b interests the longitudinal axis of the motor 100 (i.e., the axis of the shaft 102), and each housing half 12a and 12b fully surrounds half of the outer circumference of the motor 100. This allows the motor components (i.e., rear bearing support structure 140, the stator 110, and the rotor 130) to be placed into one housing half in engagement with the retaining feature before the other housing half is mounted and fastened. This is not possible in a power tool (such as second power tool 50 described below), where the housing does not include a similar clamshell structure. Here, in order to keep the motor components together—and particularly to axially constrain and pilot the rear bearing support structure 140 relative to the stator 110-a retention clip 200 is provided, as described herein detail.

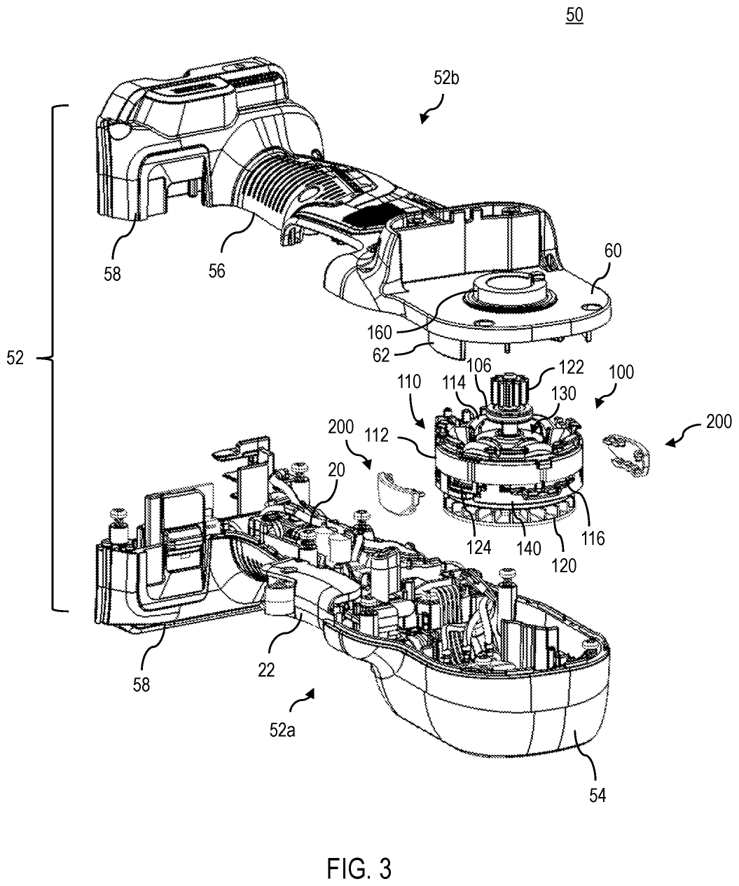

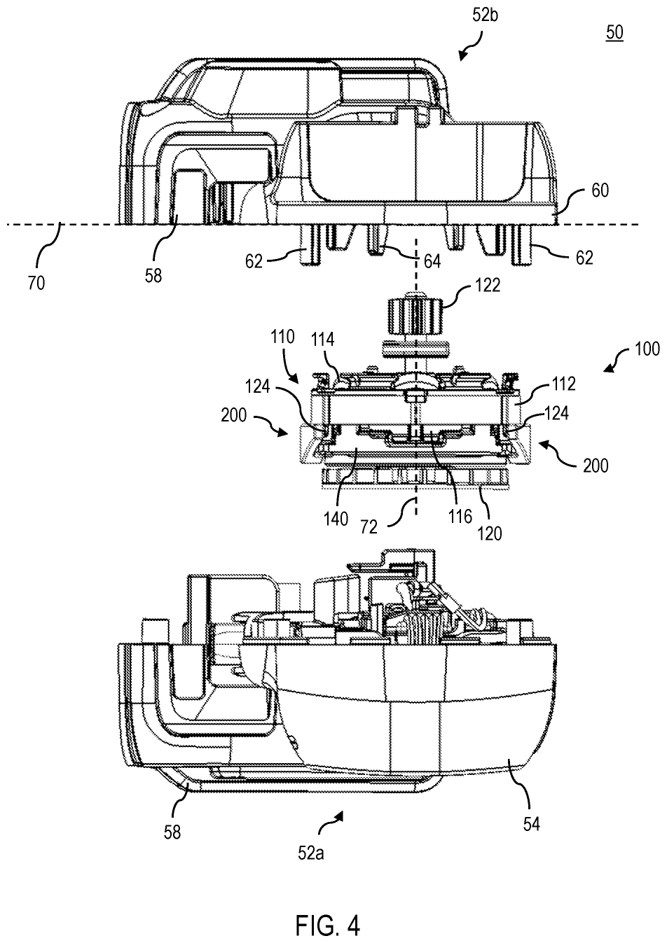

FIG. 3 depicts an exploded perspective view of the second power tool 50 provided with a retention clip 200 member to support the motor components, according to an embodiment. FIG. 4 depicts an exploded side view of the second power tool 500, according to an embodiment.

As shown in these figures, in an embodiment, second power tool 50 includes a tool housing 12 formed by a first housing half 52a and a second housing half 52b in a clamshell arrangement. The tool housing 52 forms a motor housing portion 54 that houses the electric motor 100 and a handle portion 56 extending from the motor housing portion 54 and forms a battery receptacle 58 for receiving a removeable power tool battery pack (not shown). The handle portion 56 in this example houses the control module 20 that integrally includes the input unit (e.g., a variable speed trigger assembly) 22. The second power tool 50 in this example may be a copper cutting tool, and the motor 100 may be drivably coupled to a drive mechanism (not shown) mounted on the second housing half 52b that converts the rotary motion of the motor 100 to a cutting movement made by two blades (not shown). However, it should be noted that the arrangement of the housing halves 52a and 52b show here may be employed in various other types of power tools, including grinding tools, drills, impact tools, etc.

Unlike the first power tool 10, the housing halves 52a and 52b of the second power tool 50 do not have similar structures in the motor housing portion 54. Rather, the motor housing portion 54 is formed substantially within the first housing half 52a, and the second housing half 52b includes a motor plate 60 with a substantially planar body that sits above the motor 100. Further, the motor axis 72 is perpendicular to the plane 70 formed by the mating surfaces of the housing halves 52a and 52b. The plane 70 is substantially parallel to a radial plane of the motor (i.e., a plane formed by end surfaces of the stator) and may in some examples be located completely outside the body of the stator core.

During assembly, motor 100 is placed within the motor housing portion 54 of the first housing half 52a along the direction of the motor axis 72. Since the motor housing portion does not include a clamshell structure around the motor, it is not possible for the motor housing portion 54 to include retaining features similar to retaining tabs 32 described above that can rotationally, axially and radially fix and support the stator 110 relative to the rear bearing support structure 140.

To overcome this, in an embodiment, motor 100 is provided with two retention clips 200 to structurally support and constrain motor components (i.e., in this example the stator 110 and the rear bearing support structure 140) relative to one another. As will be discussed later in detail, the retention clips 200 are provided on opposite sides of the motor and engage pockets 124 of the rear end insulator 116 and the rear surface of the rear bearing support structure 140 to hold these hold these components together. The motor housing portion 54 includes features that hold the retention clips 200 in place and in engagement with the motor components. This arrangement allows motor engineers to utilize existing frameless motors into a power tool housing that does not or cannot include retaining features for piloting and supporting motor components, without a need to redesign the motor or fasten the motor components to one another.

After the motor 100 including the retention clips 200 is positioned within the motor housing portion 54, the second housing half 52b is secured to the first housing half 54a and the motor plate 60 is mounted on the motor housing portion 54. In an embodiment, the motor plate 60 includes a series of retaining walls 62 and/or retaining posts 64 projecting therefrom into the motor housing portion 54. The retaining walls 62 are shaped to engage an outer periphery of the stator 110 on at least two opposite ends to securely pilot and support the stator 110 within the motor housing portion 54. The retaining posts 64 are designed to be securely received within slots formed between the stator windings 114 in engagement with an inner surface of the stator core 112, to rotationally and radially pilot and support the stator 110 within the motor housing portion 54. Retaining posts 64 may be construction similarly to posts 480 disclosed in US Patent Publication No. 2020/0169142 filed Jan. 29, 2020, which is incorporated herein by reference in its entirety. Additionally, the motor plate 60 itself axially constrains and supports the motor 100. In an embodiment, the motor plate 60 includes a center opening to which a bearing support insert 160 is securely mounted (e.g., press-fitted). In this embodiment, the bearing support insert 160 replaces the previously described front bearing support structure 150 to support the front bearing 106 of the motor. The pinion 122 is received through the bearing support insert 160 and is drivably coupled to the drive mechanism (not show) of the power tool 50.

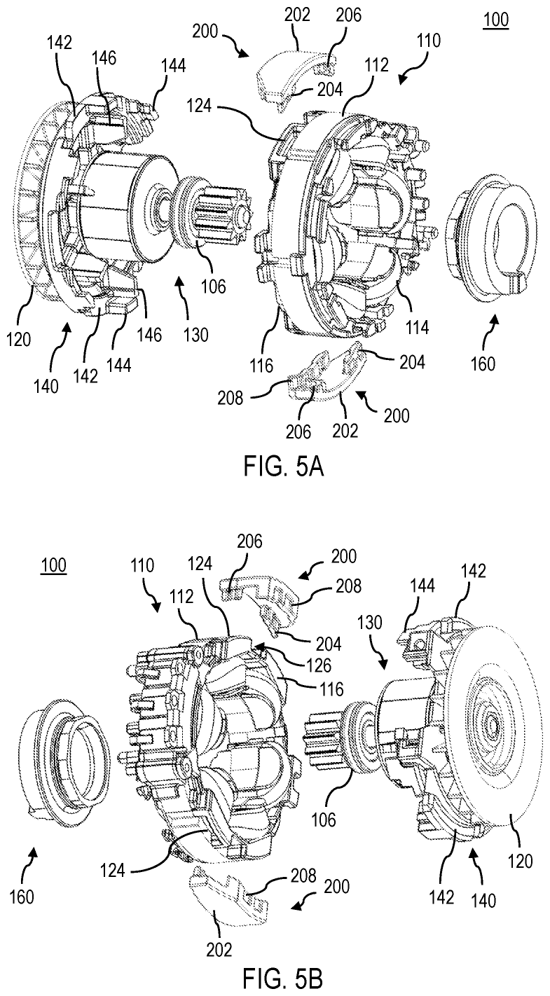

FIGS. 5A and 5B depict exploded view of the electric motor 100 and the retention clips 200, according to an embodiment.

In an embodiment, each retention clip 200 may be made of plastic material and includes a main body 202 with a curvature that approximately matches the curvature of the stator 110. The main body 202 includes a radial height of approximately 1 mm to 4 mm, extends laterally around an angular width of approximately 60 degrees to 120 degrees, and has an axial length that is approximately equal to the width of the rear end insulator 116 and the rear bearing support structure 140 combined (e.g., approximately 7 mm to 15 mm).

In an embodiment, the retention clip 200 further includes a first rear tab 204 and a second rear tab 206 projecting radially inwardly from a rear edge of the main body 202. In an embodiment, the first rear tab 204 has a lateral width that matches a lateral width of the pockets 124 of the rear end insulator 116. In an embodiment, the second rear tab 206 has a smaller lateral width, but it includes an axial length that matches an axial length of the pockets 124. This allows each retention clip 200 to fix the rear end insulator 116 axially and rotationally. In an embodiment, one retention clip 200 engages two pockets 124 of the rear end insulator 116 on one side, and the other retention clip 200 engages two pockets 124 of the rear end insulator 116 on an opposite side, to additionally provide radial support for the rear end insulator 116.

In an embodiment, the retention clip 200 additionally includes a front tab 208 projecting radially inwardly from a front edge of the main body 202. In an embodiment, the front tab 208 is designed to engage a rear surface of the rear bearing support structure 140. Specifically, in an embodiment, the rear bearing support structure 140 includes two oppositely oriented radial projections 142 that circumferentially surround its outer periphery, and the front tab 208 of each retention clip 200 engages a rear surface of one of the radial projections 142. The front tab 208 is axially distanced from the first rear tab 204 and the second rear tab 206 such that the front tab 208 can only engage the rear surface of the radial projection 142 when the rear bearing support structure 140 is fully mounted relative to the stator 110 and in full contact with the rear end insulator 116. In this manner, the two retention clips 200 cooperate to secure the rear bearing support structure 140 axially and radially to the stator 110.

In an embodiment, the rear bearing support structure 140 includes a series of axial projections 144 that fit into corresponding gaps formed between pockets 124 on the rear end insulator 116. Additionally, the rear bearing support structure 140 includes axial retaining posts 146 designed to be securely received within slots formed between the stator windings 114 in engagement with an inner surface of the stator core 112, similar to retaining posts 64 previously discussed. These features cooperate to rotationally fix the rear bearing support structure 140 to the stator 110. Together with the two retention clips 200, these features fully support the rear bearing support structure 140, axially, rotationally, and radially, to the stator 110.

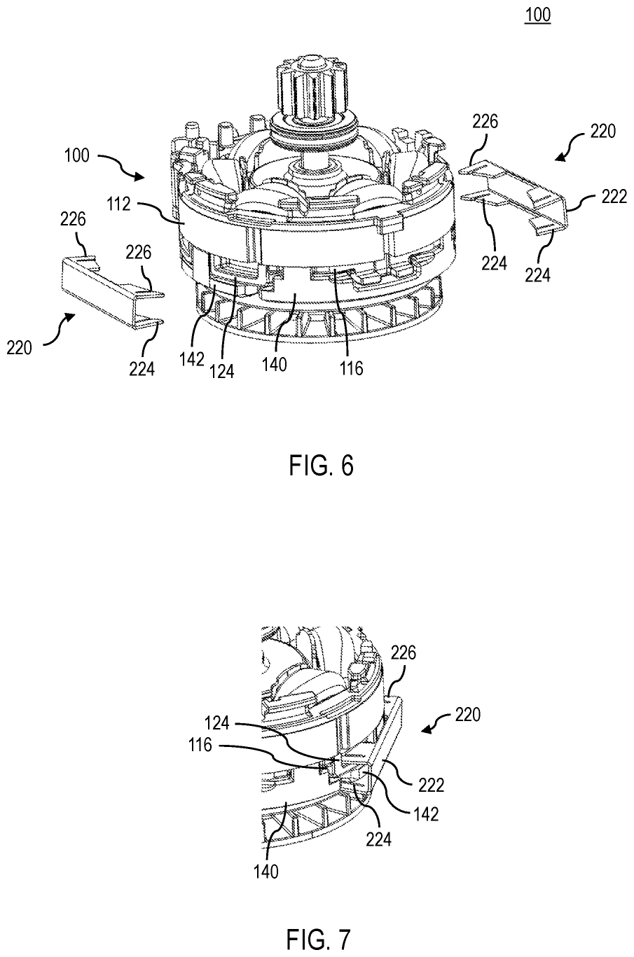

FIG. 6 depicts a perspective view of the electric motor provided with a pair of metal clips 220, according to an alternative embodiment. FIG. 7 depict a partial perspective view of the electric motor with a metal clip 220 mounted, according to an embodiment.

In an embodiment, metal clip 220 is formed from steel stamping as an alternative to the previous embodiment. In an embodiment, metal clip 220 includes a main body 222 and a series of rear legs 224 and front legs 226. The legs 224 and 226 are together stamped with the main body 222 in a single stamping process and later bent at an angle of slightly greater than approximately 90-degrees relative to the main body 222. The rear legs 224 engage the rear surface of the rear bearing support structure 140 (e.g., the rear surface of the radial projections 142), and the front legs engage the rear end insulator 116 (e.g., frontal edges of the pockets 124). The spring force applied by the metal structure of the metal clip 220 biases the rear bearing support structure 140 into contact with the end insulator 116. In this manner, the two metal clips 220 cooperate to secure the rear bearing support structure 140 axially and radially to the stator 110. All other features of the motor 100, including the rotational retention features for the motor components previously described, remain unchanged.

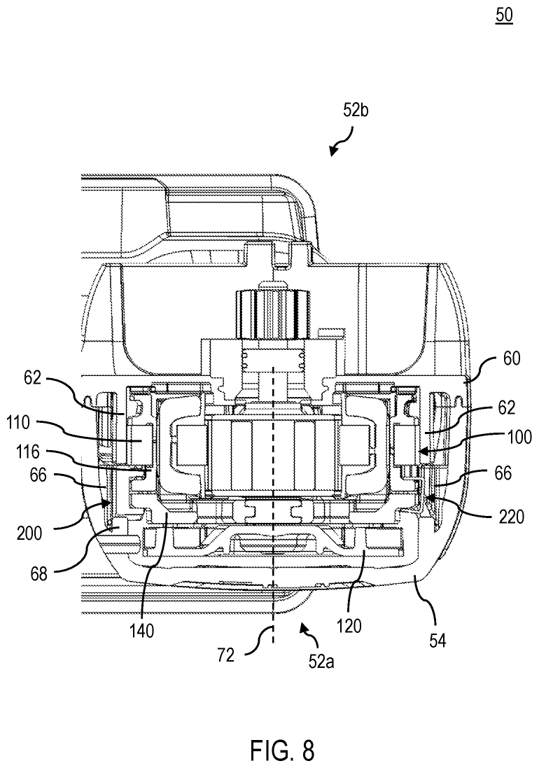

FIG. 8 depicts a side cross-sectional view of the second power tool 50 including the electric motor 100, with the retention clip 200 and the metal clip 220 mounted on two sides of the electric motor, according to an embodiment. Here, the retention clip 200 and the metal clip 220 are both depicted in the mounted positions in the same image for illustrative comparison.

Focusing initially on the retention clip 200, in an embodiment, the motor housing portion 54 includes a first interior wall 66 that is designed and oriented to contact a rear surface of the retention clip 200 when the motor 100 and the retention clip 200 are received within the motor housing portion 54. Further, the motor housing portion 54 includes a second interior wall 68 proximate the first interior wall 66 on which the retention clip 200 is seated when the when the motor 100 and the retention clip 200 are fully received within the motor housing portion 54. After the motor plate 60 is mounted on the motor housing portion 54, the retaining wall 62 of the motor plate 60 is seated against the other end of the retention clip 200 opposite the second interior wall 68. The retaining wall 62 and the second interior wall 68 are designed to be substantially aligned and located at the same distance from the center axis 72. The first and second interior walls 66 and 68 cooperate with the retaining wall 62 of the motor plate 60 to securely and firmly hold the retention clip 200 in place. In an embodiment, the first and second interior walls 66 and 68 together form a recessed compartment that securely receives the retention clip 200 and is capped off by the retaining wall 62 of the motor plate 60.

In an embodiment, the metal clip 220 may be similarly captured and retained by at least some of the same features of the motor housing portion 54 described above. However, due to the self-asserted spring force of the metal clip 220, in at least some embodiments, the metal clip 220 can be utilized without support contact with interior walls of the motor housing portion 54 and/or the motor plate 60.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Terms such as “front,” “rear,” or related terms are used herein to in relation to the direction of the power tool and/or the motor towards the power tool output and/or motor output. For example, a “rear end insulator” designates the end insulator that is further away from the motor output, and a “rear surface” of a motor component designates the surface of the component that faces away from the motor output.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A power tool comprising:
a housing including a first housing half and a second housing half mating together along a mating plane;
an electric motor disposed within the housing, the electric motor comprising a stator having a plurality of stator windings, a rotor shaft extending within the stator along a longitudinal axis, a rotor having a plurality of magnets and mounted on the rotor shaft within the stator, and a bearing support structure located adjacent the stator to support a bearing mounted on the rotor shaft; and
at least one retention clip radially mounted on the electric motor to retain the stator relative to the bearing support structure.

2. The power tool of claim 1, wherein the stator comprises a stator core and an end insulator mounted on an axial end of the stator core to electrically insulate the plurality of stator windings from the stator core, wherein the at least one retention clip engages the end insulator.

3. The power tool of claim 2, wherein the bearing support structure is in contact with the end insulator and the at least one retention clip engages opposite surfaces of the end insulator and the bearing support structure to radially and axially pilot and support the rotor relative to the stator.

4. The power tool of claim 3, wherein the end insulator includes a plurality of circumferential pockets formed in its outer surface, and the at least one retention clip is configured to engage at least one of the plurality of circumferential pockets.

5. The power tool of claim 1, wherein the longitudinal axis is substantially perpendicular to the mating plane.

6. The power tool of claim 5, wherein the first housing half includes a motor housing portion that substantially surrounds the electric motor.

7. The power tool of claim 6, wherein the second housing half includes a motor plate that mates with the motor housing portion to house the electric motor, wherein the motor plate includes a front bearing support structure that supports a front bearing mounted on the rotor shaft to provide structural support for the rotor, and at least one retaining feature coupled to the stator to provide structural support for the stator.

8. The power tool of claim 6, wherein the motor housing portion includes at least one interior wall that holds the at least one retention clip in engagement with the stator and the bearing support structure.

9. The power tool of claim 1, wherein the at least one retention clip comprises two retention clips positioned on opposite circumferential sides of the electric motor.

10. The power tool of claim 1, wherein each retention clip includes a main body having curvature and extends laterally around an angular width of approximately 60 degrees to 120 degrees of the circumference of the electric motor, a front tab extending radially inwardly from the main body that engage the stator, and a rear tab extending radially inwardly from the main body that engages the bearing support structure.

11. The power tool of claim 10, wherein an axial distance between the front tab and the rear tab is configured to ensure that the front and rear tabs fully engage the stator and the bearing support structure only when the bearing support structure is fully mounted relative to the stator.

12. The power tool of claim 1, wherein each retention clip is a metal clip comprising stamped metal shaped to include a plurality of legs that engage the stator and the bearing support structure.

13. The power tool of claim 1, wherein the electric motor includes a frameless structure with no fasteners that fasten the stator to the bearing support structure.

14. An electric motor comprising:
a stator having a plurality of stator windings;
a rotor shaft extending within the stator along a longitudinal axis;
a rotor having a plurality of magnets and mounted on the rotor shaft within the stator;
a bearing support structure located adjacent the stator to support a bearing mounted on the rotor shaft; and
at least one retention clip radially mounted on the electric motor to retain the stator relative to the bearing support structure.
